(19) United States
(12) Patent Application Publication
(10) Pub. No.: US 2003/0145170 A1
(43) Pub. Date: Jul. 31, 2003

(54) Dynamically adjusted cache power supply to optimize for cache access or power consumption

(76) Inventor: Wayne D. Kever, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 10/062,212

(22) Filed: Jan. 31, 2002

(51) Int. Cl. G06F 13/00

(52) U.S. Cl. 711/122

(57) ABSTRACT

A system and method for optimizing the power consumption or the access time of a subdivided cache memory system is described. An adjustable voltage power supply provides power to a section of a subdivided cache. The voltage to this section may be increased, yielding a faster access time. The voltage to this section may also be decreased. Decreasing the voltage to this section decreases the power consumed by the cache memory system.

### CROSS-REFERENCED RELATED APPLICATIONS

This application is related to an application titled “A Simplified Cache Hierarchy by using Multiple Tags and Entries into a Large Subdivided Array”, H.P. docket number 10016667-1 filed on or about the same day as the present application.

### FIELD OF THE INVENTION

This invention relates generally to electronic circuits. More particularly, this invention relates to improving cache memory performance and reducing cache memory power consumption.

### BACKGROUND OF THE INVENTION

As the size of microprocessors continues to grow, the size of the cache memory included on a microprocessor chip may grow as well. In some applications, cache memory may utilize more than half the physical size of a microprocessor. Methods to reduce the size of cache memory are needed.

On-chip cache memory on a microprocessor may be divided into groups: one group stores data and another group stores addresses. Within each of these groups, cache may be further grouped according to how fast information may be accessed. A first group, usually called L1, may consist of a small amount of memory, for example 16 k bytes. L1 usually has very fast access times. A second group, usually called L2, may consist of a larger amount of memory, for example 256 k bytes, however the access time of L2 may be slower than L1. A third group, usually called L3, may have even a larger amount of memory than L2, for example 4 M bytes. The memory contained in L3 may have slower access times than L1 and L2.

A “hit” occurs when the CPU asks for information from a section of the cache and finds it there. A “miss” occurs when the CPU asks for information from a section of the cache and the information isn't there. If a miss occurs in a L1 section of cache, the CPU may look in a L2 section of cache. If a miss occurs in the L2 section, the CPU may look in L3.

Since performance is a major reason for having a memory hierarchy, the speed of hits and misses is important. Hit time is the time to access a level of the memory hierarchy, this includes the time needed to determine whether the access is a hit or a miss. The miss penalty is the time to replace the information from a higher level of cache memory, plus the time to deliver the information to the CPU. Because an lower level of cache memory, for example L1, is usually smaller and usually built with faster memory circuits, the hit time will be much smaller than the time to access information from a higher level of cache memory, for example L2.

Tags are used to determine whether a requested word is in a particular cache memory or not. An individual tag may be assigned to each individual cache memory in the cache hierarchy. FIG. 1 shows a cache hierarchy with three levels of cache memory. Tag L1, 108 is assigned to Cache L1, 102 and they are connected through bus 118. Tag L2, 110 is assigned to Cache L2, 104 and they are connected through bus 120. Tag L3, 112 is assigned to Cache L3, 106 and they are connected through bus 122. Bus 114 connects Cache L1, 102 and Cache L2, 104. Bus 116 connects Cache L2, 104, and Cache L3, 106. A tag should have enough addresses to access all the words contained in a cache. Larger caches require larger tags and smaller caches require smaller tags.

When a miss occurs, the CPU may have to wait a certain number of cycles before it can continue with processing. This is commonly called a “stall.” A CPU may stall until the correct information is retrieved from memory. A cache hierarchy helps to reduce the overall time to acquire information for processing. Part of the time consumed during a miss, is the time used in accessing information from a higher level of cache memory. If the time required to access information from a higher level could be reduced, the overall performance of a CPU could be improved.

The cross-referenced related application titled, “A Simplified Cache Hierarchy by using Multiple Tags and Entries into a Large Subdivided Array”, H.P. docket number 10016667-1 filed on or about the same day as the present application, describes a cache hierarchy that uses a section of a subdivided cache as another cache. The current invention described provides an adjustable voltage power supply to the cache defined as a section of a subdivided cache. The adjustable voltage power supply may increase or decrease the voltage applied to the cache defined as a section of a subdivided cache. Increasing the voltage to this section decreases the access time of the cache. Decreasing the voltage to this section, decreases the power consumed by the cache.

The invention described improves overall CPU performance. It also reduces the average power consumed by cache memory.

### SUMMARY OF THE INVENTION

An embodiment of the invention provides a system and a method for reducing the access time or reducing the power consumed in a section of a subdivided cache. An adjustable voltage power supply provides power to a section of a subdivided cache. The voltage to this section may be increased, yielding a faster access time. The voltage to this section may also be decreased. Decreasing the voltage to this section decreases the power consumed by the cache memory system.

Other aspects and advantages of the present invention will become apparent from the following detailed description, taken in conjunction with the accompanying drawing, illustrating by way of example the principles of the invention.

### BRIEF DESCRIPTION OF THE DRAWINGS

FIG. 1 is a schematic drawing of a cache memory hierarchy containing three cache memory elements controlled by three TAGs.

FIG. 2 is a schematic drawing of a cache memory hierarchy where one cache memory array is a subset of another cache memory array.

FIG. 3 is a schematic drawing of a subdivided cache memory hierarchy where an adjustable voltage power supply provides power to a smaller cache.

### DETAILED DESCRIPTION OF THE PREFERRED EMBODIMENT

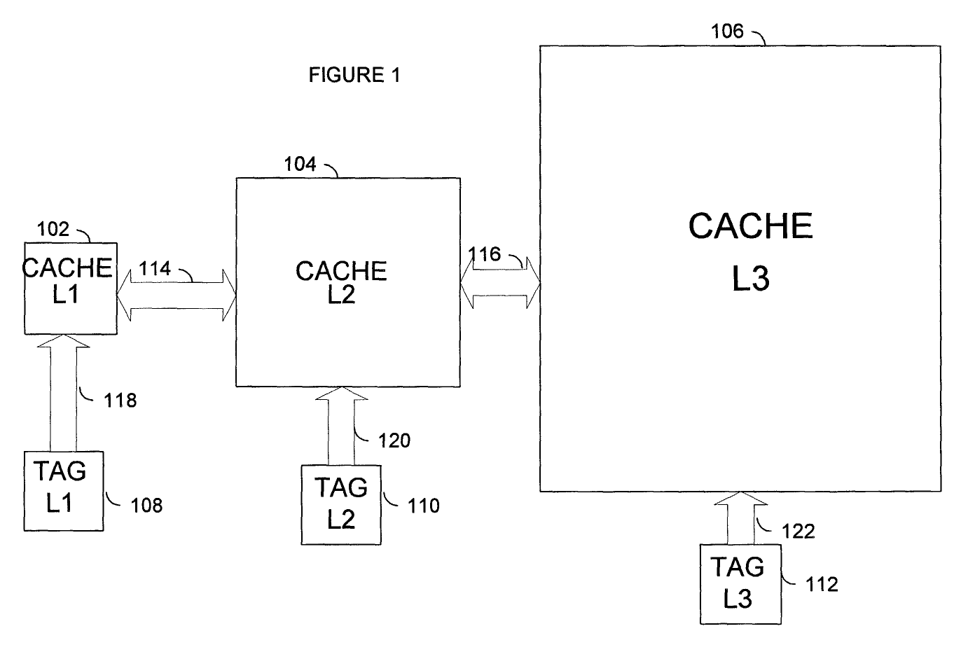

FIG. 1 shows a cache hierarchy with three levels of cache memory. Tag L1, 108 is assigned to Cache L1, 102 and they are connected through bus 118. Tag L2, 110 is assigned to Cache L2, 104 and they are connected through bus 120. Tag L3, 112 is assigned to Cache L3, 106 and they are connected through bus 122. Bus 114 connects Cache L1, 102 and Cache L2, 104. Bus 116 connects Cache L2, 104, and Cache L3, 106. A tag should have enough addresses to access all the words contained in a cache. Larger caches require larger tags and smaller caches require smaller tags.

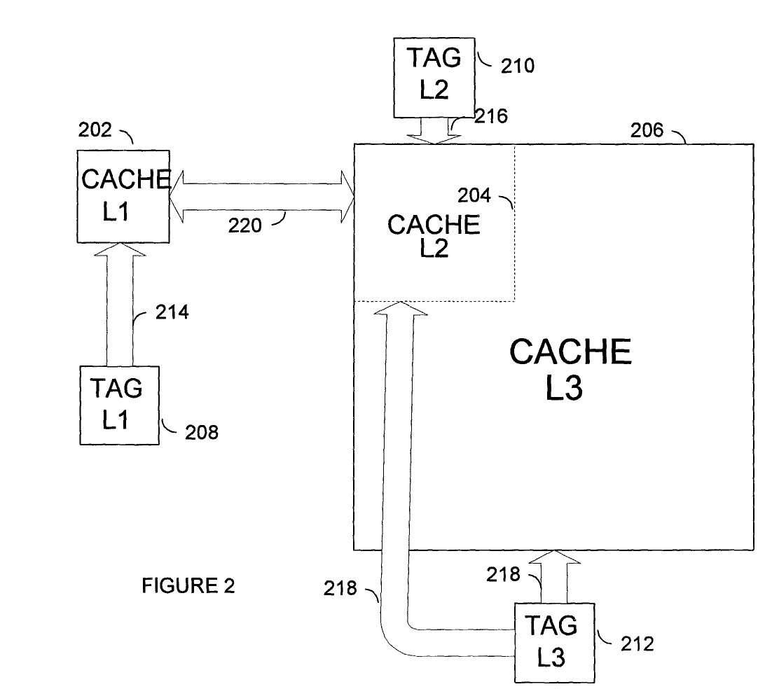

Each cache in FIG. 1 one is physically distinct from the other. Each cache has a tag associated with it. FIG. 2 illustrates how physical memory may be shared between two caches. In FIG. 2, cache L1, 202, is physically distinct from caches L2 and L3. Cache L1, 202, is controlled by tag L1, 208, through bus 214. Cache L2, 204 consists of a physical section of cache L3, 206. Tag L2, 210, controls only cache L2, 204 while tag L3, 212, controls cache L3, 206. Since cache L2, 204 is part of cache L3, 206, tag L3, 212 also controls cache L2, 204. Bus 220 connects cache L1, 202, to cache L2, 204, and to part of cache L3, 206. Tag L2, 210, controls cache L2, 204, through bus 216. Tag L3, 212, controls cache L3, 206 through bus 218.

Because cache L2, 204 is a subset of cache L3, 206, a bus between them is not necessary. The information contained in cache L2, 204, is also part of cache L3, 206. Removing the need for a bus between L2, 204, and L3, 206, reduces the size and complexity of the cache hierarchy. It also helps reduce the power consumed in the cache hierarchy. Size and power are also reduced when cache L2, 204, physically shares part of the memory of cache L3, 206. In a standard cache hierarchy, as shown in FIG. 1, cache L2, 104, is physically distinct from cache L3, 106. As a result, a standard hierarchy, as shown in FIG. 1, may use more area and more power than the hierarchy shown in FIG. 2.

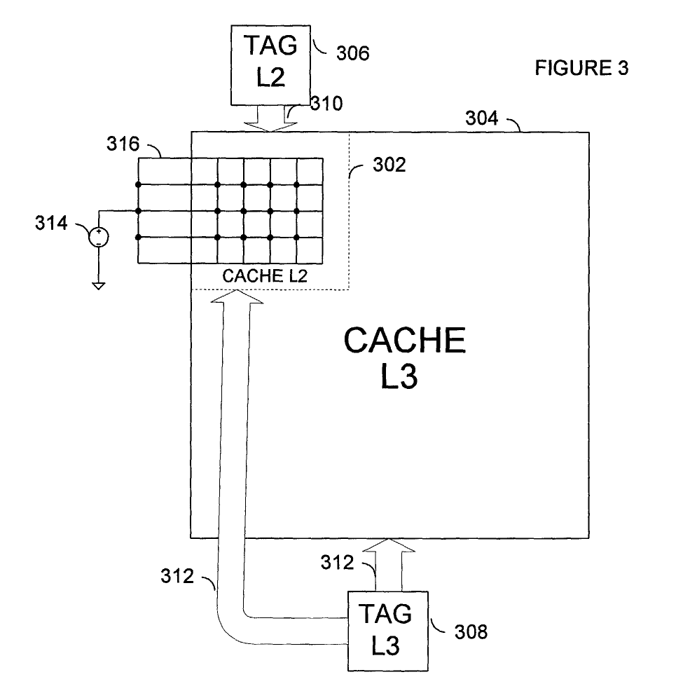

FIG. 3 illustrates how an adjustable voltage power supply may be added to a section of a subdivided cache. 314 in FIG. 3 represents an adjustable voltage power supply. 316 in FIG. 3 represents a power grid that supplies power to cache L2, 302. Cache L2, 302 is physically part of cache L3, 304. Because cache L2, 302 is physically part of cache L3, 304, the information stored in cache L2, 302, is also stored in cache L3, 304. Tag L2, 306, controls cache L2, 302 through bus 310. Tag L3, 308, controls cache L2, 302, and cache L3, 304, through bus 312.

The voltage supplied by an adjustable voltage power supply 314 to grid 316 may be varied to suit the requirements of an application. For example, if an application needs faster access times from cache L2, 302, the voltage from the adjustable voltage power supply may be increased. If an application doesn't need reduced access times from cache L2, 302, the power consumed by cache L2, 302, may be reduced. The power is reduced by lowering the voltage supplied by the adjustable voltage power supply, 314, on the power grid, 316, of cache L2, 302. In this manner, the power and access time of cache L2, 302 may be dynamically adjusted to suit the requirements of the application being run.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A cache memory system comprising:
a first cache memory;
a second cache memory;
an adjustable voltage power supply electrically connected to said first cache memory;
a first tag electrically connected to said first cache memory;
a second tag electrically connected to said first and said second cache memories;
wherein said first cache memory is a subset of said second cache memory;
wherein said first tag controls said first cache memory and said second tag controls said first and said second cache memories.

2) The cache memory system as in claim 1 wherein said adjustable voltage power supply lowers voltage applied to said first cache to reduce power.

3) The cache memory system as in claim 1 wherein said adjustable voltage power supply raises voltage applied to said first cache to reduce access time.

4) A method of reducing power consumed by a subdivided cache memory system comprising:
fabricating an adjustable voltage power supply;
fabricating a first tag and a second tag;
fabricating a first cache memory;
wherein a second cache memory is a subset of said first cache memory;
wherein said second tag controls said second memory and said first tag controls said first and said second cache memories;
wherein said adjustable voltage power supply is electrically connected to said second cache memory;
wherein said adjustable voltage power supply lowers voltage applied to said second cache memory.

5) A method of decreasing access time in a subdivided cache memory system comprising:
fabricating an adjustable voltage power supply;
fabricating a first tag and a second tag;
fabricating a first cache memory;
wherein a second cache memory is a subset of said first cache memory;
wherein said second tag controls said second memory and said first tag controls said first and said second cache memories;
wherein said adjustable voltage power supply is electrically connected to said second cache memory;
wherein said adjustable voltage power supply raises voltage applied to said second cache memory.
